(19) United States
(12) Patent Application Publication
(10) Pub. No.: US 2008/0192740 A1
(43) Pub. Date: Aug. 14, 2008

(54) Processing Realtime Media Streams

(75) Inventors: Stephen Lorusso, Weston, MA (US); Elmer Lyons, Chelmsford, MA (US)

Correspondence Address: SIEMENS SCHWEIZ AG;I-47, INTELLECTUAL PROPERTY, ALBISRIEDERSTRASSE 245, ZURICH, CH-8047, omitted

(73) Assignee: NOKIA SIEMENS NETWORKS GMBH & CO. KG, Munich (DE)

(21) Appl. No.: 11/885,645

(22) PCT Filed: Mar. 3, 2006
(86) PCT No.: PCT/EP06/01961

§ 371 Date: Sep. 4, 2007

Related U.S. Application Data
(60) Provisional application No. 60/658,738, filed on Mar. 4, 2005.

(51) Int. Cl. H04L 12/28

(52) U.S. Cl. 370/389

(57) ABSTRACT

In a data network having an internal data network, an external data network and an interface that connects the internal data network to the external data network, a method for processing packetized real-time media streams includes receiving an external data packet of a media stream by the interface from the external data network. The external data packet is analyzed and a media stream to which the external data packet belongs is identified. An internal data packet which comprises a context label is created. The context label identifies the media stream to which the internal data packet belongs.

The present invention relates to data networks and in particular to systems and methods for processing packetized real-time media streams in data networks according to claims 1, 4 and 9.

When addressing to layers in this document, the layers of the open systems standards model are meant.

In this document the term “media stream” describes a flow of real time application data, typically video and/or audio data. Typically a media stream in this sense is a flow of data to an application peer. The data is encapsulated in some manner compliant with a transmission network.

Applications that require real time media streams are becoming increasingly popular and increasingly bandwidth consuming, due to an increased quality. Examples of such applications are voice over internet protocol (VoIP), internet video or audio services. Media stream therefore usually refers to a transmission of audio, video or a combination of the two.

Real time applications over packet based data networks, like for example internet protocol telephony require deep packet inspection of data packets. For example a stream terminator needs to find out the destination's application level address in order to process a data packet. This information is to be found in several higher layer headers, usually layer 3 and above.

According to the state of the art, the current solution in order to process real time media streams in packet based data networks is to require all network devices to perform security, firewall, network address translation and classification operations. All participants in the network therefore must support extensive packet classification and manipulation capabilities. This requires complex hardware and/or software designs that are relatively inefficient and expensive.

The MPLS specifications describe a mechanism of layer-2 encapsulation. MPLS was developed to encapsulate each complete packet traversing a predefined network path with a path-specific label. However, the end consumer of the MPLS-encapsulated data receives the full packet and must process it in its entirety. Since the paths were defined as routable ‘trunks’ of user traffic between network points, the MPLS operations do not differentiate different traffic classes or users of the path with different labels.

The problem to be solved by the invention is therefore to enable a method and a system that require reduced packet inspection for processing packetized real-time media streams.

This problem is solved by the technical features of claim 1, claim 4 and/or claim 9.

A data network comprises an internal data network, an external data network and an interface that connects the internal data network and the external data network.

In a first aspect of the invention an external data packet of a media stream is transmitted from the external data network to the interface. The interface then analyses the external data packet and identifies the media stream to which the external data packet belongs. The interface then creates an internal data packet. The internal packet comprises a context label. The context label identifies the media stream to which the internal data packet belongs.

The information necessary to identify the media stream can in many cases be found in the headers of layer 3, 4, 5, 6 and/or 7.

In order to enable a quick localization of the context label as possible it is advantageous to write it in a layer as low as possible. To write the context label in layer two is therefore a very advantageous solution, however the context label can also be located in layer 3 or above.

When the internal data packet is forwarded from the interface to a network node of the internal data network, said network node only needs to read the context label and assign the internal data packet to the media stream.

In a second aspect of the invention an internal data packet is transmitted from the internal data network to the interface. The internal data packet comprises a context label. The context label identifies the media stream to which the internal data packet belongs. The context label is then read by the interface and a remote destination of the media stream in the external data network is identified. The interface then creates an external data packet which conforms to an addressing method of the external data network and which comprises as a destination address an address of the remote destination and/or of a remote application peer.

The following advantageous embodiments are possible for all aspects of the invention:

When the context label consists of a fixed number of bits and/or the context label is written at a fixed position in the internal data packet, it can be found, read and written very quickly.

By administrating the assignment of context labels to media streams by means of a central policy controller which is comprised by the internal data network, the internal network can be easily controlled. The central policy controller allows more precise context management within the solution, which leads to higher solution utility. However, a single policy controller is not necessary. The peers could use any predetermined method to receive each other's context information (i.e. the context label). This could be via a central controller or a direct peer-to peer exchange. Context labels can be managed by the central controller or by the peers themselves.

The internal data packet can simply be an encapsulation of the external data packet. All headers that are comprised in the external data packet are then also comprised in the internal data packet. The advantage of this is that mere encapsulation is easier to perform than supplementary manipulation of the data packets. However, all information in headers of the external data packet are not required for the internal data packet if the information is comprised in the context label. Therefore if the external data packet comprises at least one header which is not comprised by the internal data packet, the size of a internal packets can be reduced, which results in a decreased bandwidth consumption for the internal data network. Especially if all headers of the external data packet, which comprise the same information as the context label of the corresponding internal data packet are not comprised by the internal data packet, a maximum of bandwidth saving can be achieved.

In another advantageous embodiment the internal data network is a controlled network, while the external data network is uncontrolled.

In other words:

This invention presents a method by which individual packetized real-time media streams are associated with and distinguished by a unique header. Especially proprietary layer 2 headers are suited. The header provides a consistent identification of the session without incurring extensive upper-layer packet inspection. Its intended use would be in controlled networks where not all devices may have deep packet inspection capabilities.

In particular, this invention describes an encapsulation method, which in this document is also called PIRPLE, to be applied to ingress traffic by devices at the network periphery. The encapsulation header conceptually contains the portion of the result of the security, firewall, network address translation and classification operations that is required by the devices on the interior of the network. Some of these operations may be completed at the periphery and have no contribution to the PIRPLE encapsulation (e.g. security, denial of service attacks, network parameters).

A packet classifier analyzes each incoming data packet to match it with a predefined media context label. The classifier either prepends the entire packet or some portion thereof in a PIRPLE header. PIRPLE hereby stand for “Path Identification for Reduced-Processing Link Encapsulation”. The modified packet is then forwarded to a consumer of the encapsulated data that has no classification capabilities, but instead a simple PIRPLE header processor.

Real-time streaming media devices specialize in the processing of media data and do not have the ability to perform extensive (or even minimal) network or transport-level communication protocol processing without the addition of complex and expensive pre-processing devices. In a trusted network all security, firewall, network address translation and classification operations should be performed at the periphery so that internal devices can avoid such operations and thus be more cheaply developed and operate more efficiently.

In an application that has implemented the invention, only the devices at the network edge need to support the full packet treatment capabilities. Internal devices need only to support PIRPLE with simple, cheap hardware.

This invention therefore describes an encapsulation method to be applied to ingress traffic by devices at the network periphery. The encapsulation header conceptually contains the portion of the result of the security, firewall, network address translation and classification operations that is required by the devices on the interior of the network. Some of these operations may be completed at the periphery and have no contribution to the PIRPLE encapsulation (e.g. security, denial of service attacks, network parameters).

In contrast to existing technologies like for example MPLS, the invention is able to differentiate individual streams of user traffic in a point-to-point network. The end consumer of the MPLS-encapsulated data receives the full packet and must process it in its entirety. Since the PIRPLE payload may be a portion of the original packet, the end consumer need not process the entire original packet.

In the following the invention is described in an exemplary way based on the figures:

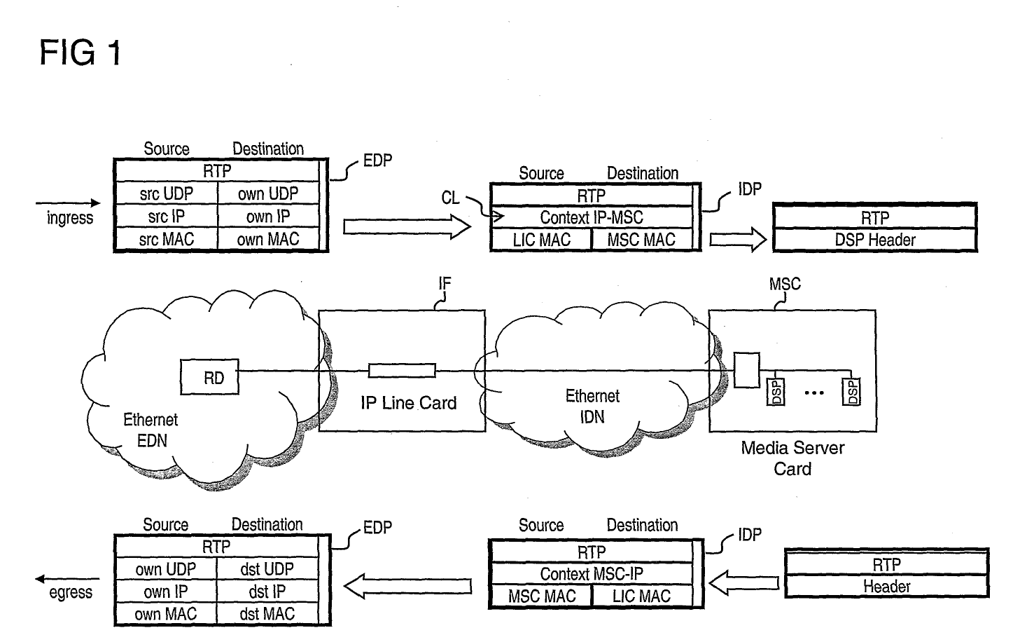

FIG. 1 a scheme of a first embodiment of the invention

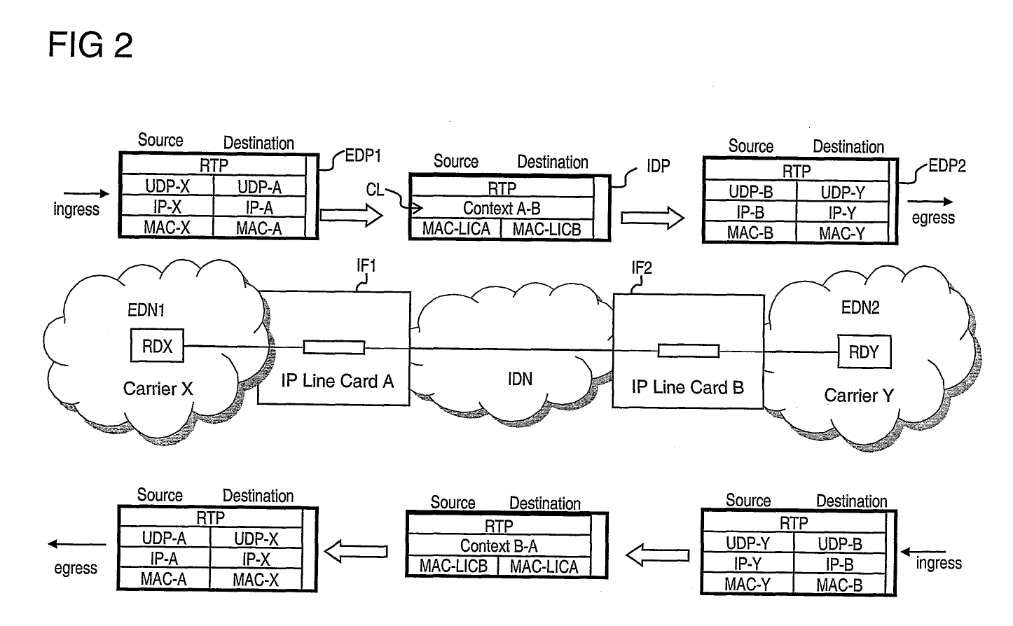

FIG. 2 a scheme of a second embodiment of the invention

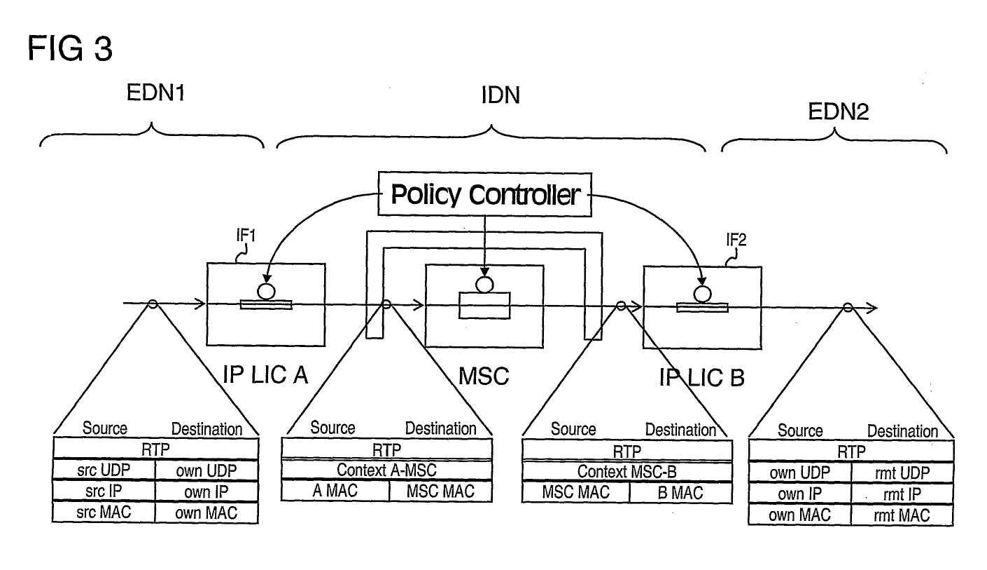

FIG. 3 a scheme of a third embodiment of the invention

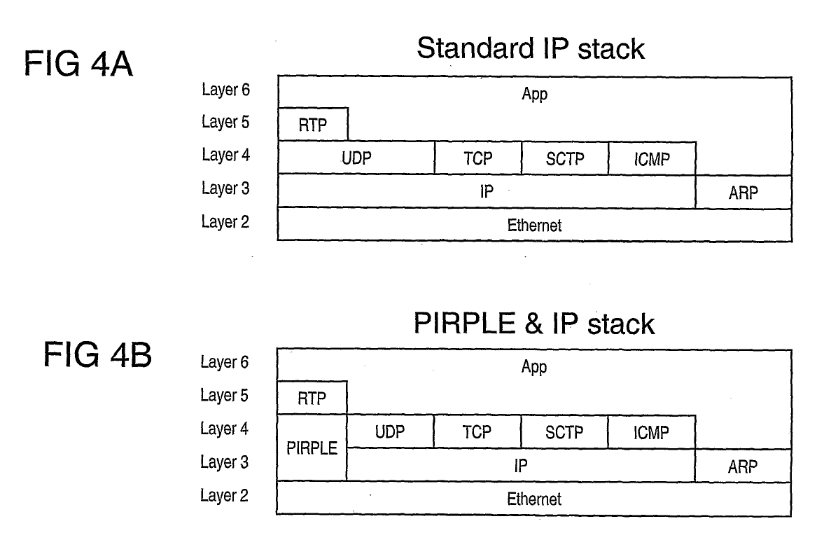

FIG. 4A a protocol stack according to the state of the art

FIG. 4B a protocol stack in a fourth embodiment of the invention

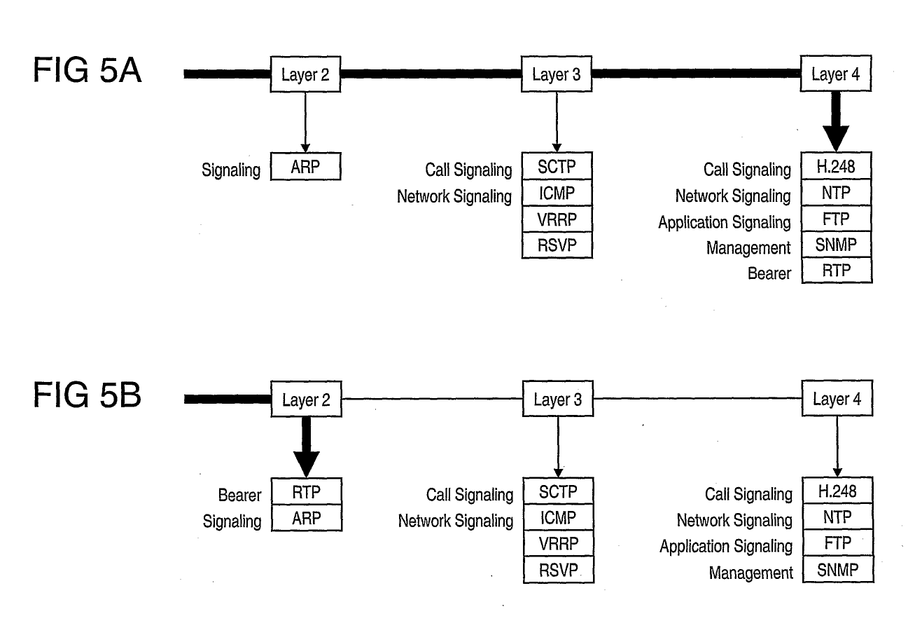

FIG. 5A a scheme of the classification of a data packet at its destination according to the state of the art

FIG. 5B a scheme of the classification of a data packet at its destination in a fifth embodiment of the invention

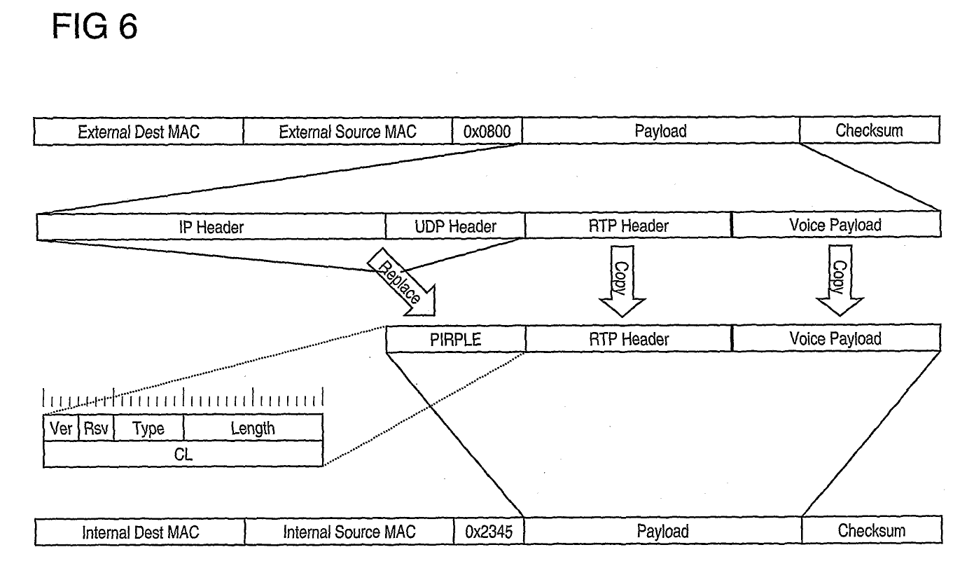

FIG. 6 a scheme of the generating of an internal data packet in a sixth embodiment of the invention

FIG. 1 shows a scheme of first embodiment of the invention. A data network comprises an internal data network IDN and an external data network EDN. In this example the external data network EDN is an Ethernet and internet protocol based network. An IP-line-card operates as an interface IF that connects the internal data network IDN to the external data network EDN. The internal data network IDN further comprises a media server card MSC, which comprises at least one digital signal processor DSP.

A real time media stream is established between a remote destination RD in the external data network EDN and a digital signal processor DSP of the media server card MSC. In order to transmit information from the remote destination RD in the external data network EDN to a digital signal processor DSP in the internal data network IDN, the following steps are performed:

An ingress external data packet EDP of a real time media stream enters from the external data network EDN into the IP line card IF. The external data packet EDP comprises a source MAC-address “src MAC” and a destination MAC-address “own MAC” in the layer 2 header, a source IP-address “src IP” and a destination IP-address “own IP” in the layer 3 header, a source UDP address “src UDP” and a destination UDP “own UDP” address in the layer 4 header. The external data packet additionally comprises higher layer header, such as a real time transport protocol header “RTP” and a payload. In many applications several of these headers comprise information about the media stream.

In the IP line card IF the external data packet EDP is analyzed in order to identify the media stream to which the external data packet EDP belongs. The analysis can comprise deep packet inspection, especially analysis of the header of layer 3 and layer 4 and analysis of the pay load.

When the media stream to which the external data packet EDP belongs is identified, the IP line card creates an internal data packet IDP which comprises in a layer 2 header as a MAC source address the local MAC address “LIC MAC” of the IP line card IF and as a MAC destination address the local MAC address “MSC MAC” of a media server card MSC. In another header the modified data packet comprises a context label CL “Context IP-MSC” which identifies the media stream to which the external data packet EDP and the internal data packet IDP belong. The internal data packet IDP also comprises the payload of the external data packet EDP. In this example the MAC addresses, IP addresses and destination addresses of the external data packet EDP were discarded in order to create the internal data packet, i.e. they are not contained in the modified data packet. In other embodiments the internal data packet IDP is generated by encapsulating the external data packet EDP with a header which comprises the context label.

The IP line card sends the internal data packet IDP over the internal data network IDN to the media server card MSC. From there on it can be further processed and forwarded to one of the digital signal processors DSP. As a practical example, a digital signal processor DSP can be an electronic module to which a headset or a VoIP telephone is plugged in order to establish a VoIP connection. In this example, the digital signal processors DSP are the devices that terminate the media payload. The are usually the most computation intensive component of the media delivery process.

Instead of performing a deep packet inspection of the original external data packet, the media server card and other network nodes in the internal data network IDN only need to look up the context label CL in order to identify the media stream to which the modified data packet belongs. In order to forward the relevant information (i.e. the RTP or media payload) to the digital signal processor DSP, the local MAC addresses of the IP line card IF and of the media server card MSC can be discarded. Optionally the media server card MSC can also replace the context label CL with a header which comprises an address of the digital signal processor DSP which processes the media stream.

In many applications bi-directional communication is necessary. For example for an IP-Phone call, information of the media stream must also be transmitted in the backward direction, i.e. from the digital signal processor DSP to the remote destination RD. Therefore the media server card MSC generates an internal data packet IDP, which comprises the context label CL of a media stream. The internal data packet IDP is transmitted to the IP line card IF. The IP line card IF reads the context label CL and generates an egress external data packet EDP which conforms-to the addressing methods of the external data network EDN and which comprises as a destination addresses “dst MAC”, “dst IP”, “dst UDP” of the remote destination RD. The source addresses of the external data packet EDP are the addresses “own MAC”, “own IP”, “own UDP” of the IP line card IF.

By sending out the external data packet EDP to the external data network EDN, the external data packet EDP will be forwarded to the remote destination RD.

FIG. 2 shows a scheme of a second embodiment of the invention. A data network comprises an internal data network IDN, a first external data network EDN1 of a carrier X and a second external data network EDN2 of a carrier Y. A first IP-line-card A operates as a first interface IF that connects the internal data network IDN to the first external data network EDN1. A second IP-line-card B operates as a second interface IF that connects the internal data network IDN to the second external data network EDN2.

A real time media stream is established between a first remote destination RDX in the first external data network EDN1 and a second remote destination RDY in the second external data network EDN2. In order to transmit information from the first remote destination RDX to second remote destination RDY, the following steps are performed:

An ingress first external data packet EDP1 of a real time media stream enters from the first external data network EDN1 into the first IP line card A. The first external data packet EDP1 comprises as source addresses addresses of the first remote destination RDX, i.e a source MAC-address “MAC-X”, a source IP-address “IP-X” and a source UDP address “UDP-X” As destination addresses the first external data packet comprises addresses of the first line card A, i.e. a MAC-address “MAC-A”, an IP-address “IP-A” and a UDP address “UDP-A”. In addition the data packet comprises higher layer headers, such as e.g. a real time transport protocol header RTP and a payload. In many applications these headers comprise information about the media stream.

In the first IP line card A the first external data packet EDP1 is analyzed in order to identify the media stream to which the external data packet EDP belongs. The analysis can comprise deep packet inspection, especially analysis of the header of layer 3 and layer 4 as well as analyses of higher layers.

When the media stream to which the first external data packet EDP1 belongs is identified, the first IP line card A creates an internal data packet IDP which comprises in a layer 2 header as a MAC source address the local MAC address “MAC-LICA” of the first IP line card A and as a MAC destination address the local MAC address “MAC-LICB” of the second IP Line Card B. In another header the modified data packet comprises a context label “Context A-B” CL, which identifies the media stream to which the first external data packet EDP1 and the internal data packet IDP belong. The internal data packet IDP also comprises the real time transport protocol header RTP and the payload of the first external data packet EDP1. In this example the MAC addresses, IP addresses and UDP addresses of the first external data packet EDP1 were discarded in order to create the internal data packet IDP, i.e. they are not contained in the modified data packet. This way less bandwidth of the internal data network IDN is used. In other embodiments the internal data packet IDP is generated by encapsulating the external data packet EDP1 with a header which comprises the context label CL.

The first IP line card A sends the internal data packet IDP over the internal data network IDN to the second IP line card B. When the internal data packet IDP is forwarded through the internal data network, the network nodes of the internal data network IDN need not to perform deep packet inspection of the internal data packet. In order to determine the media stream to which the internal data packet IDP belongs it is sufficient to read the context label CL.

Also the second IP line Card B now only needs to look up the context label “Context A-B” CL in order to identify the media stream to which the data packet belongs. The second line card B then generates a second external data packet EDP2, which conforms to an addressing method of the second external data network EDN2 and which comprises as a destination address the address of the second remote destination RDY, e.g. the MAC-address “MAC-Y”, the IP-address “IP-Y” and the UDP address “UDP-Y”. As source addresses the second external data packet comprises the addresses of the second IP-line Card B, i.e. the MAC-address “MAC-B”, the IP-address “IP-B” and the UDP address “UDP-B”.

By sending out the second external data packet EDP2 to the second external data network EDN2, the second external data packet EDP2 will be forwarded to the second remote destination RDY.

For bi-directional communication, in order to transmit data from the second remote destination RDY to the first remote destination RDX the same principles apply.

FIG. 3 shows a scheme of a data network in a third embodiment of the invention. A data network comprises an internal data network IDN, a first external data network EDN1 and a second external data network EDN2. A first IP-line-card A operates as a first interface IF that connects the internal data network IDN to the first external data network EDN1. A second IP-line-card B operates as a second interface IF that connects the internal data network IDN to the second external data network EDN2. The internal data network IDN comprises a Media Server Card MSC and a policy controller. The first IP line Card “IP LIC A” and the second IP line card “IP LIC B” are each connected to the media server card MSC. The policy controller is connected to all network nodes of the internal data network IDN, thus to the first IP line card A, to the media server card MSC and to the second IP line card B. The policy controller is responsible for maintaining a consistent assignment of context labels CL to media streams. In an advantageous embodiment the control system pushes PIRPLE policy down to the bearer-path subsystems.

FIG. 4A shows an example of a standard IP protocol stack for voice over IP real time media streams. The standard IP stack comprises in layer 2 Ethernet; in layer 3 internet protocol IP and address resolution protocol ARP; in layer 4 user datagram protocol UDP, transmission control protocol TCP, stream control transmission protocol SCTP and internet control message protocol ICMP; in layer 5 real-time transport protocol RTP. Layers 4, 5 and/or 6 are used to implement an application App.

FIG. 4B shows an example of a protocol stack according to a fourth embodiment of-the invention for a voice over IP real time media stream. The protocol stack comprises the same protocols as in FIG. 4A, with the difference, that layer 3 and layer 4 are replaced by a single PIRPLE layer, when a data packet carries a real time transport protocol RTP payload. The PIRPLE layer represents the PIRPLE-header, which comprises the context label for the media stream.

FIG. 5A shows an example of the classification of a data packet at its destination, e.g. in a media server card, according to the state of the art. A large number of headers ARP, SCTP, ICMP, VRRP, RSVP, H.248, NTP, FTP, SNMP, RTP have to be processed in order to classify the data packet. The heavy arrow indicates the relative traffic that is being classified.

FIG. 5B in contrast shows an example the classification of an internal data packet at its destination, e.g. in a media server card, in a fifth embodiment of the invention. Again, the heavy arrow indicates the relative traffic that is being classified. In order to classify an internal data packet of a real time media stream, only a real time transport protocol header RTP and an address resolution protocol header ARP have to be processed.

FIG. 6 shows an example for generating an internal data packet in a sixth embodiment of the invention. From a layer 2 point of view an external data packet comprises an external destination MAC address, an external source MAC address, an ethertype field “0x0800”, a layer 2—payload and a checksum. The layer 2—payload comprises IP-, UDP- and RTP-headers and a voice-payload. In order to generate the internal data packet, the IP-header and the UDP-header are replaced by a PIRPLE header, while the external MAC-addresses are replaced by internal MAC-addresses and the RTP-header and the voice-payload are copied into the internal data packet. In addition the internal data packet is marked with a proprietary ethertype value “0x2345”, which indicates that the data packet is an internal data packet. Also the checksum of the external data packet is replaced by a checksum for the internal data packet.

The PIRPLE header captures the complete classification of the ingress packet to allow simple classification of the payload within the internal network. (Example: the MSC only needs to lookup the CL to find the associated media processing resource)

In the embodiment of FIG. 6 the PIRPLE header comprises the following fields

Version Ver: 4 bit value indicating header version.

Reserved Rsv: 4 bits for future expansion.

Type: 8 bit value indicating the type of context packet and format of the context header.

Length: 16 bit value for the length in octets of the payload.

Context label CL: 32 bit value provided by the CP. This is unique for each bearer path session.

However, the PIRPLE header and in particular the context label CL can take any form useful to identify a destination of the internal data packet.

### LIST OF REFERENCE SIGNS

| | |
|---|---|
| App | Application |
| CL | context label |
| DSP | digital signal processor |
| EDN, EDN1, EDN2 | external data network |
| EDP, EDP1, EDP2 | external data packet |
| IDN | internal data network |
| LIC, IF | interface |
| MSC | media server card |
| RD, RDX, RDY | remote destination |

### LIST OF ACRONYMS

| | |
|---|---|
| ARP | Address Resolution Protocol |
| FTP | File Transfer Protocol |
| H.248 | Media Gateway Controller (RFC 3525) |
| ICMP | Internet Control Message Protocol |
| IP | Internet Protocol |
| MAC | Media Access Protocol |
| NTP | Network Time Protocol |
| RSVP | Resource Reservation Protocol |
| RTP | Real-time Transport Protocol |
| SCTP | Stream Control Transmission Protocol |
| SNMP | Simple Network Management Protocol |
| TCP | Transmission Control Protocol |
| UDP | User Datagram Protocol |
| VRRP | Virtual Router Redundancy Protocol |

1. A method for processing packetized real-time media streams in a data network, the data network comprising an internal data network, an external data network and an interface that connects the internal data network to the external data network, the method comprising the steps of:
receiving an external data packet of a media stream by the interface from the external data network;
analyzing said external data packet and identifying a media stream to which the external data packet belongs; and
creating an internal data packet which comprises a context label, said context label identifying the media stream to which the internal data packet belongs.

2. The method according to claim 1, wherein
the identification of the media stream is performed by analyzing at least one of a layer 3 header, a layer 4 header, a layer 5 header, a layer 6 header, and a layer 7 header of the external data packet.

3. The method according to claim 1, further comprising
forwarding the internal data packet to a network node of the internal data network, said network node reading the context label and assigning the internal data packet to the media stream.

4. A method for processing packetized real-time media streams in a data network, the data network comprising an internal data network, an external data network and an interface that connects the internal data network to the external data network, the method comprising the steps of
receiving an internal data packet of a media stream by the interface from the internal data network, said internal data packet comprising a context label identifying the media stream to which the internal data packet belongs,
reading the context label of the internal data packet and identifying in the external data network a remote destination of the media stream to which the internal data packet belongs; and
creating an external data packet which conforms to an addressing method of the external data network and which comprises as a destination address an address of the remote destination.

5. The method according to claim 4, wherein
the context label is comprised by at least one of a layer 2 header, a layer 3 header and a layer 4 header of the internal data packet.

6. The according to claim 4, wherein
the context label consists of a fixed number of bits and the context label is written at a fixed position in the internal data packet.

7. The method according to claim 4, wherein
the internal data network comprises a policy controller, whereas said policy controller administrates the assignment of context labels to media streams.

8. The method according to claim 4, wherein
the external data packet comprises at least one header which is not comprised by the internal data packet.

9. (canceled)

10. The according to claim 4, wherein the context label is written at a fixed position in the internal data packet.

11. The method according to claim 1, wherein the context label is comprised by at least one of a layer 2 header, a layer 3 header and a layer 4 header of the internal data packet.

12. The according to claim 1, wherein the context label consists of a fixed number of bits and the context label is written at a fixed position in the internal data packet.

13. The method according to claim 1, wherein the internal data network comprises a policy controller, whereas said policy controller administrates the assignment of context labels to media streams.

14. The method according to claim 1, wherein the external data packet comprises at least one header which is not comprised by the internal data packet.

15. The according to claim 4, wherein the context label is written at a fixed position in the internal data packet.

16. A system for processing packetized real-time media streams in a data network, the data network comprising an internal data network, an external data network and an interface that connects the internal data network to the external data network, comprising:
means for receiving an external data packet of a media stream by the interface from the external data network;
means for analyzing said external data packet and identifying a media stream to which the external data packet belongs; and
means for creating an internal data packet which comprises a context label, said context label identifying the media stream to which the internal data packet belongs.

17. A system for processing packetized real-time media streams in a data network, the data network comprising an internal data network, an external data network and an interface that connects the internal data network to the external data network, comprising:
means for receiving an internal data packet of a media stream by the interface from the internal data network, said internal data packet comprising a context label identifying the media stream to which the internal data packet belongs;
means for reading the context label of the internal data packet and identifying in the external data network a remote destination of the media stream to which the internal data packet belongs; and
means for creating an external data packet which conforms to an addressing method of the external data network and which comprises as a destination address an address of the remote destination.
